(19) United States
(12) Patent Application Publication
(10) Pub. No.: US 2024/0346237 A1
(43) Pub. Date: Oct. 17, 2024

(54) CONTENT GENERATION SYSTEM

(71) Applicant: YAMAHA HATSUDOKI KABUSHIKI KAISHA, Iwata-shi (JP)

(72) Inventor: Haruyoshi HINO, Shizuoka (JP)

(21) Appl. No.: 18/637,896

(22) Filed: Apr. 17, 2024

Related U.S. Application Data
(63) Continuation-in-part of application No. PCT/JP2023/015385, filed on Apr. 17, 2023.

(51) Int. Cl. G06F 40/166; G06F 16/332; G06F 16/9538; G06T 11/00; G06T 13/80

(52) U.S. Cl. CPC G06F 40/166; G06F 16/3329; G06F 16/9538; G06T 11/00; G06T 13/80

(57) ABSTRACT

Using communicative human language information inputted through the User Interface (UI), an LLM (Language Learning Model) acquires communicative human language information to include in the content. Simultaneously, using the communicative human language information inputted through the UI, the LLM acquires information for selecting visualization software capable of generating visual information to include in the content. Based on the acquired communicative human language information, the visualization software is selected. According to the communicative human language information inputted through the UI, the selected visualization software is operated based on the text information acquired from the LLM's output. Visual information for inclusion in the content is acquired, and content containing at least a part of the acquired communicative human language information and at least a part of the acquired visual information is generated and outputted.

### TECHNICAL FIELD

This invention relates to a content generation system.

### BACKGROUND TECHNOLOGY

Text generation systems utilizing large language models (LLM: Large Language Model), such as GPT-2 and GPT-3, have been proposed (Patent Document 1). Recently, GPT-4 has been released, and various use-cases are being actively discussed (Non-Patent Document 1).

### PRIOR ART REFERENCES

### Patent Literature

[Patent Document 1] U.S. Patent Application Publication No. 2021/192140

### Non-Patent Literature

[Non-Patent Document 1] “GPT-4 finally released: explaining how to use GPT-4 and its performance,” [Online], Mar. 15, 2023, ChatGPT Research Institute, [Searched on Mar. 21, 2023], Internet <URL: https://chatgpt-lab.com/n/n7facbf0f8890>

### SUMMARY OF INVENTION

### Problem to be Solved by the Invention

It is desired to use LLMs (GPT-3 or above) to generate content that is more easily understood by people, in an efficient manner.

The objective of this invention is to use LLMs to generate content that is more easily understood by people efficiently. More specifically, the objective is to both facilitate user's understanding of the content and to improve the efficiency of content generation, thereby reducing the load on hardware resources constituting the content generation system.

### Means for Solving the Problem

This invention can provide the following content generation system.

A content generation system comprising:
at least one user interface,
at least one memory,
at least one processor configured to execute at least one program stored in said memory and connected to said memory, wherein
said at least one program is programmed to:
(A) utilize both a Large Language Model (LLM) that operates using communicative human language information entered through said user interface, and a visualization software programmed to output visual information using provided text information,
(B) acquire communicative human language information to be included in the content by the LLM using at least part of the communicative human language information entered through said user interface,
(C) acquire communicative human language information to select visualization software that is capable of generating visual information to be included in the content, based on at least part of the communicative human language information entered through said user interface, and also select the visualization software based on the acquired information,
(D) acquire visual information to be included in the content by operating the selected visualization software using acquired text information that is based on the output of the LLM in correspondence to the communicative human language information entered through said user interface,
(E) generate content including at least a part of the communicative human language information or its modification acquired from (B) and at least a part of the visual information or its modification acquired from (D), and
(F) output the generated content through said user interface.

This content generation system uses an LLM to efficiently generate content that is easier for people to understand. In this system, users do not need to choose the visualization software themselves, and the content generation system selects the appropriate visualization software based on user's needs. This enables both the enhancement of user's understanding of the content and improvement in the efficiency of content generation. This content generation system does not assume the use of specific visualization software. Because the content generation system selects visualization software based on user's needs, there is no need for the content generation system to be configured for each visualization software. As a result, the system's versatility is improved, and the load that is on the hardware resources that constitute the content generation system can be reduced. In other words, more advanced processing is possible if the same hardware resources are used.

The content generation system includes at least one user interface, at least one memory, and at least one processor. At least one user interface, at least one memory, and at least one processor are connected so that they can communicate with each other. At least one user interface, at least one memory, and at least one processor may be installed on a single device to build a centralized processing system, or they may be distributed across multiple devices to construct a distributed processing system. Here, the term “distributed processing system” can be broadly interpreted to include a local system, a cloud system, or a combination of both. If the content generation system is a distributed processing system, the user terminal device may be included among the multiple devices that constitutes the system. Moreover, a program related to the content generation system can be installed on the user terminal device, and the user terminal device can function as a content generation system by executing the program on at least one of its processors. If the content generation system includes a user terminal device, the user interface is the input and output devices provided on the user terminal device. Input devices may include keyboards and pointing devices, while output devices may include displays, projectors, printers, speakers, and earphones.

The content generation system can accept input through the user interface based on communicative human language information and can output content. The content generation system may be based on an LLM. In this case, the content generation system may be multimodal. In one embodiment, the content generation system has the functionality of a chatbot that can input and output communicative human language information through the user interface. In this embodiment, the chatbot is based on an LLM (LLM-based chatbot). The content generation system can iteratively convey communicative human language information through the user interface or with the LLM. The content generation system can maintain context during this iterative information exchange. Moreover, in one embodiment, the content generation system is not integrated into any specific visualization software and is not associated only with specific visualization software. The visualization software to be selected is not determined before the start of use of the content generation system.

“Content” includes communicative human language information and visual information. Content is generated based on “communicative human language information entered through the user interface.” The information “communicative human language information entered through the user interface.” is, for example, “please generate explanatory material on technical matter X” in the embodiment below, which includes the subject matter of the contents and is, in its nature, a query. Here, a query consists of commands, requests, questions or a combination thereof to the content generation system (e.g., “please generate explanatory material on . . . ”). The query may also include commands, requests, questions, or a combination thereof about specifications of the content (e.g., quantity, language, layout). The subject matter is, for example, a matter that the user wants to explain or convey to someone (e.g., “technical matter X”). The subject matter may include, for example, themes or topics. The “communicative human language information entered via the user interface” need not necessarily be entered all at once; it may be entered through multiple rounds of input and output between the user and the content generation system via the user interface. Furthermore, the “communicative human language information entered via the user interface” does not include information that indicates the name of the visualization software. The choice of visualization software is not made by the user but by the content generation system. However, information indicating the name of the visualization software may be entered into the content generation system.

Contents are, for example, generated to describe or explain the subject matter in accordance with the query. The communicative human language information and visual information in the contents are related to each other and the subject matter. Contents are generated to facilitate understanding of the subject matter and to describe or explain the subject matter in more detail. As one example, the communicative human language information within the content has a greater number of text compared to the communicative human language information entered through the user interface. The visual information, for example, is added to complement the explanations or descriptions given by the communicative human language information.

Examples of “content” may include documents, presentation materials, and videos. As for documents, examples are technical explanatory documents, intellectual property-related documents submitted to administrative agencies or courts, intellectual property appraisal documents, and intellectual property search documents. The content generation system may generate these documents or their drafts. Examples of documents related to intellectual property rights include patent specifications, Office Action response documents, and documents for trials or litigation. Intellectual property appraisal documents may pertain to infringement or non-infringement and may also concern the validity of the rights. Intellectual property search documents could pertain to, for example, infringement or non-infringement, prior art searches, or trend surveys. Note that things where visual information is the primary output with communicative human language information included as an additional output, do not fall under what is termed here as “content.” For instance, movies, TV shows, video game walkthroughs, and sports videos do not qualify as “content” in this context.

Communicative human language information refers to language information that can be understood, recognized, and remembered by people. Communicative human language information is based on the language system used by people in everyday conversations. Communicative human language information can be conveyed as text information or audio information. Programming languages do not fall under communicative human language information. The term ‘programming languages’ here includes not only low-level languages (machine languages and assembly languages (ASM)) but also high-level languages (interpreted languages and compiled languages). The following types of information may utilize communicative human language information and may also include programming languages. In this context, programming languages are not used for execution by a processor but are used to present information to people. In one embodiment, the following types of information do not include programming languages that are conveyed for execution by a processor:
Information entered into the content generation system through the user interface;
Information entered into the LLM to operate it; or
Information included in the content along with visual information.

Visual information can be either images or videos. Images are static visual information while videos are dynamic. Images can be either visualizations or non-visualizations. Visualizations are images derived from data or information. Data can be raw material for information. Examples of visualizations include figures, graphs, charts, diagrams, plots, histograms, tables, and matrices. For figures, examples like contour maps, topographic maps, vector diagrams, equipotential surface maps, mechanical drawings, design drawings, and patent drawings can be cited. Non-visualizations could be, for example, photographs that were actually taken. Visualizations may also be generated based on one or multiple non-visualizations. Videos may be animations or simulations, and may also be live-action captures. At least part of the visual information in the content may be generated by visualization software or may be generated by visualization software and then modified by a content generation system. Visual information acquired through internet search does not belong to the visual information generated by visualization software in the content generation system. Animations or simulations may also be generated based on one or multiple live-action captures. Animations or simulations may contain one or multiple non-visualizations and/or visualizations.

A user interface is a device and/or equipment included in the content generation system that facilitates the mutual exchange of information between the system and the user. If the content generation system is configured without including a user terminal device but is capable of communication, the user interface may be, for example, a communication module that enables communication with the user terminal device. If the content generation system includes a user terminal device, the user interface may include input and output devices of the user terminal device.

A processor encompasses central processing units (CPUs), microprocessors, general-purpose processors, digital signal processors (DSPs), graphic processing units (GPUs), controllers, microcontrollers, programmable logic devices (PLDs), field-programmable gate arrays (FPGAs), and application-specific integrated circuits (ASICs). Multiple processors can be configured in any combination of these. The execution of a program by at least one processor need not be confined to the execution by a single processor; it can also be parallel processing in a multiprocessor configuration. In multiprocessors, either symmetrical or asymmetrical multiprocessing may be employed. Multiprocessors can be either tightly coupled or loosely coupled. The processor may also be a multicore processor.

Memory includes RAM, ROM, non-volatile RAM, PROM, EPROM, EEPROM, flash memory, magnetic data storage, optical data storage, registers, or any combination of these. Memory can be either singular or multiple.

An LLM refers to a language model with a large number of parameters. An LLM is capable of executing natural language processing tasks. An LLM may also be a natural language generation model, based on an LLM, capable of generating sentences from inputted communicative human language information. Generating new sentences from inputted communicative human language information is one example of a natural language processing task.

The number of parameters in an LLM may be, for example, more than 1 billion, more than 10 billion, or even more than 100 billion. A language model is something that models communicative human language using the probability of language occurrence. In one embodiment, an LLM can perform inference without fine-tuning, using methods like zero-shot learning (ZSL), one-shot learning (OSL), or few-shot learning (FSL). In one embodiment, the LLM is configured to perform tasks and produce outputs based on the input prompts, which contain communicative human language information. Examples of LLMs include but are not limited to GPT-3, GPT-4, GShard, Switch Transformer, Gopher, and HyperCLOVA. LLMs may or may not be included in a content generation system and may communicate with a content generation system.

Visualization software is not particularly limited, and can be data visualization software or can include Visual Foundation Models (VFM), for example. If multiple visual elements are included in a single piece of content, each visual element may be generated by different visualization software. In this case, the processor may select visualization software for each visual element.

Process (A) includes processes (B) to (D). In the following embodiments, processes (B), (C), and (D) are executed in this order. Moreover, communicative human language information is supplied from the content generation system to the LLM in each of the processes (B) to (D). However, the order of processes (B) to (D) is not particularly limited. Processes (B) to (D) do not need to be temporally or content-wise strictly distinguished from each other. It suffices that process (A) (i.e., processes (B) to (D)) and process (E) are completed before content is outputted in process (F). If each of processes (B) to (D) includes multiple sub-processes, the sub-processes relating to (B) to (D) can be performed interchangeably. The supply of communicative human language information from the content generation system to the LLM may be common in all or any two of processes (B) to (D). In any case, the results of previously executed processes can be used in subsequently executed processes.

In process (B), some or all of the communicative human language information input through the user interface may be used. The communicative human language information inputted via the user interface may be the same or different from the communicative human language information supplied to the LLM. In one embodiment, information supplied to the LLM in process (B) mainly includes communicative human language information inputted through the user interface.

Based on the subject matters included in communicative human language information inputted through the user interface, tasks can be set, and prompts based on these tasks can be supplied to the LLM. In a case where the task is predefined to elaborate or describe the input matters in more detail, prompts may be supplied to the LLM based on the subject matters included in the input and the predefined tasks. In this context, the prompts can be interpreted as being the input matters, and the communicative human language information for content can be, for example, a detailed explanation of the input matters. Process (B) may be iteratively executed multiple times. In this case, one or more matters (e.g., words, phrases, expressions, or sentences) are first extracted from the explanation of the subject matters acquired from the LLM, and then the extracted matters may be supplied to the LLM. Also, if an explanation about these matters is acquired from the LLM, more specific sub-concepts related to the matters can be extracted from this explanation and supplied to the LLM. This enables the generation of a more detailed explanation about the technical matters. Contents generated through such a process can contain a detailed explanation or description about the subject matters, as well as even deeper and more detailed explanations or descriptions about the matters contained in the said explanation or description.

In Process (C), either some or all of the communicative human language information entered via the user interface may be utilized. Regarding Process (C), in one embodiment, the information supplied to the LLM in Process (C) primarily comprises the communicative human language information entered via the user interface. Choosing visualization software based on the communicative human language information acquired from the LLM can encompasses the following processes. If the communicative human language information includes the name of the visualization software, the processor can directly select that software by such name. Alternatively, the processor can conduct a web search using the communicative human language information, acquire communicative human language and/or visual information, and then select the visualization software based on these findings. Web searches may involve searching for visual information (e.g., image search) or communicative human language information (e.g., text search). It is not necessary for the visualization software options available to the content generation system to be identified before the system is used. For example, one or more visualization software options can be selected from those available via networks like the Internet. Also, multiple visualization software options could be identified before the system is used. For instance, visualization software can be selected based on the subject matter included in the communicative human language information entered via the user interface. Since the content generation system performs the selection, the user does not need to choose the visualization software based on the desired content.

Regarding Process (D), the text information acquired based on the output of the LLM can either be identical to the information outputted by the LLM or alternatively can be modified from the information outputted by the LLM. This text information corresponds to or is related to the communicative human language information entered via the user interface, although this text information may differ from it. The processor executes the input of this text information in a format that is compatible with the visualization software, without requiring input from the user. In other words, the “text information acquired based on the output of the large language model” in Process (D) implies that between the input via the user interface and the output of the LLM, both of which can be text information sources in the LLM, the output of the LLM serves as the basis for the text information. However, in addition to the output of the LLM, the input via the user interface may also serve as a basis for the text information.

In Process (E), the generated content includes both at least a portion of the communicative human language information acquired in Process (B) or its modification, and at least a portion of the visual information acquired in Process (D) or its modification. The phrase ‘at least a portion’ means that the content does not necessarily have to include all of the communicative human language information acquired in Process (B) or all of the visual information acquired in Process (D). The term ‘modification’ refers to alterations made to the information acquired in either Process (B) or (D) by the content generation system. In other words, the content can include modifications in addition to or instead of the information acquired in Process (B) or (D). These modifications should not substantively change the conveyed information. The layout of communicative human language information and visual information in the content is not particularly limited and may, for example, be automatically determined by the processor or could be determined according to requests entered via the user interface.

In Process (F), the manner of outputting the content is not particularly limited. It may involve providing a file of the content, or it may involve displaying the content itself.

### Effect of Invention

According to this invention, by utilizing an LLM, a content generation system can efficiently generate content that is easier for people to understand.

### BRIEF DESCRIPTION OF THE DRAWINGS

FIG. 1A is a system overview diagram explaining the content generation system relating to an embodiment of this disclosure. FIG. 1B is a flowchart explaining the processes carried out by the content generation system.

### EMBODIMENT FOR IMPLEMENTING THE INVENTION

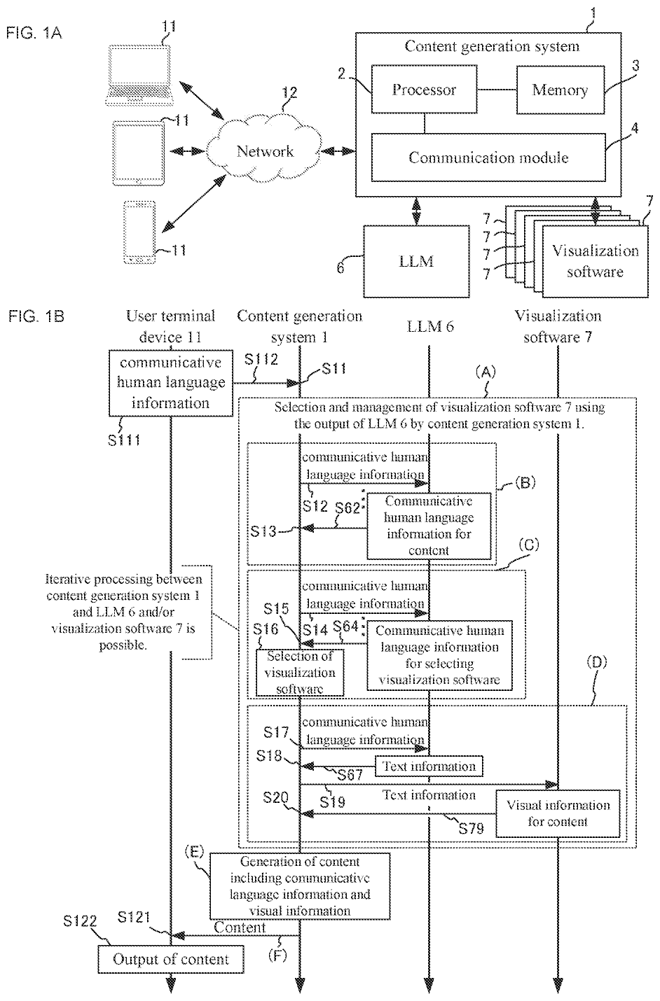

FIG. 1A is a system overview diagram that explains the content generation system 1 relating to an embodiment of this disclosure.

The content generation system 1 comprises a processor 2, and memory 3 and communication module 4 which are communicatively connected to processor 2. Memory 3 stores programs for executing processes (A) to (F). Processor 2 executes these programs. In this embodiment, the communication module 4 corresponds to a user interface. The number of processors 2 and memory units 3 is not particularly limited and may be one or multiple. The hardware configuration of content generation system 1 is not limited. The content generation system 1 may be configured by a single server device or multiple server devices that can communicate with each other. In this case, the multiple server devices may be configured to provide cloud computing services. Communication module 4 enables communication between processor 2 and user terminal devices 11, a LLM 6, and multiple visualization software 7.

Multiple user terminal devices 11 can communicate with content generation system 1 through network 12. The number of user terminal devices 11 is not limited. Examples of user terminal devices 11 shown in the diagram include PC devices, tablet devices, and mobile phones. However, user terminal devices 11 are not limited to these examples. Various types of terminal devices that can be used by users can be used as user terminal devices 11.

Network 12 enables communication between multiple user terminal devices 11 and content generation system 1. The type of network 12 is not limited and can be constructed from various types of wired or wireless networks, or a combination thereof. The communication method is not limited, nor is the communication protocol.

The LLM 6 is stored in one server device or multiple server devices that can communicate with each other. These one or more server devices can communicate with content generation system 1. LLM 6 outputs to content generation system 1 in response to input from content generation system 1. Such input is, for example, communicative human language information. Such output is, for example, communicative human language information in response to the above input and is also text information used for input to visualization software 7.

Multiple visualization software 7 are each stored in one server device or multiple server devices that can communicate with each other. These server devices can communicate with content generation system 1 via networks such as the Internet. In other words, each visualization software 7 is available for the content generation system 1 via network 12 such as the Internet. From multiple visualization software 7, one or more may be selected by content generation system 1. The selected visualization software 7 outputs to content generation system 1 in response to input from content generation system 1. Such input is, for example, text information acquired from the LLM 6. Such output is, for example, visual information generated using the text information.

FIG. 1B is a flowchart that explains the processes carried out by content generation system 1. Hereafter, an example case is described where a user inputs “Please generate explanatory material on technical matter X” into user terminal device 11 as communicative human language information. However, this is just an example, and the communicative human language information input is not limited to this example.

First, the user inputs into the user terminal device 11 a communicative human language information request to “generate explanatory material about technical matter X” (Step S111).

The user terminal device 11 may be running software or an application related to the services provided by the content generation system 1 or displaying a relevant website on a web browser. In this state, communicative human language information is inputted by the user. The inputted communicative human language information has a subject matter (“generate explanatory material about technical matter X”). The entered communicative human language information is sent by the user terminal device 11 via network 12 to the content generation system 1 (Step S112). In the content generation system 1, the processor 2 receives the communicative human language information via the communication module 4 (Step S11).

### Processing (A)

After step S111, the processor 2 utilizes both the LLM 6 and visualization software 7 (Process (A)). In process (A), the selection and management of visualization software 7 is performed by the content generation system 1 utilizing the output of LLM 6. This management targets the selected visualization software 7 and involves the utilization of the visualization software 7 for explaining or describing the subject matter included in the communicative human language information. Process (A) includes the following processes (B) to (D). In Process (A), iterative processing can be performed between the content generation system 1 and the LLM 6 and/or visualization software 7.

### Process (B)

After step S111, the processor 2 acquires communicative human language information for inclusion in the content based on the input received via communication module 4 (Process (B)). In this process (B), first, the processor 2 supplies communicative human language information to the LLM 6 (step S12). After step S12, communicative human language information intended for the content is supplied from the LLM 6 to the content generation system 1 (step S62). As a result, the processor 2 acquires communicative human language information for inclusion in the content through the LLM 6 (step S13). Although process (B) is executed iteratively in this embodiment, this is not an exclusive example. In this embodiment, the processor 2 acquires detailed explanations about technical matter X as communicative human language information for inclusion in the content through multiple iterations of process (B). This explanation includes a general formula for explaining technical matter X, as well as variables contained in this general formula.

### Process (C)

Next, the processor 2 uses the communicative human language information entered via communication module 4 to acquire communicative human language information from the LLM 6 for selecting visualization software 7 that is capable of generating visual information to be included in the content. Based on the acquired communicative human language information, the processor 2 selects the visualization software 7 (process (C)).

In this process (C), first, processor 2 supplies communicative human language information to the LLM 6 (Step S14). In this embodiment, since process (B) is carried out before process (C), the communicative human language information acquired in process (B) is used in process (C). As mentioned above, in process (B), the processor 2 acquires a general formula for explaining the technical matter X, as well as the variables included in this formula. In step S14, the processor 2 provides a query to the LLM 6 about visualization software 7 that is capable of generating visual information using the general formula and variables as communicative human language information.

After Step S14, communicative human language information for selecting visualization software 7 is supplied from the LLM 6 to the content generation system 1 (Step S64). As a result, the processor 2 acquires communicative human language information for selecting visualization software 7 from the LLM 6 (Step S15). In this embodiment, the communicative human language information acquired in Step S15 includes the name of visualization software 7 that is capable of generating visual information using the general formula and variables. Based on the acquired communicative human language information, the processor 2 selects the visualization software 7 (Step S16).

### Process (D)

Next, the processor 2 acquires visual information for inclusion in the content by operating the selected visualization software 7 in Step S16, based on text information acquired from the output of the LLM 6 in response to communicative human language information entered via the communication module 4 (Process (D)).

In Process (D), first, the processor 2 supplies communicative human language information to the LLM 6 (Step S17). In this embodiment, Processes (B) and (C) are performed before Process (D), and the communicative human language information acquired in Processes (B) and (C) is used in Process (D). Specifically, the processor 2 submits enquires to the LLM 6 regarding the type and value of data that should be inputted into visualization software 7 to acquire visual information representing technical matter X. As a result, text information is supplied from the LLM 6 to the content generation system 1 (Step S67). Thus, the processor 2 acquires text information from the LLM 6 (Step S18), which includes the type and value of data to be inputted in a format compatible with the visualization software 7.

In Process (D), the processor 2 supplies the text information to the visualization software 7 (Step S19). The visualization software 7 is stored in a manner that allows it to operate on one or multiple server devices. The visualization software 7 operates using the text information to generate visual information. As previously stated, in this embodiment, the text information includes the type and value of data that should be inputted. Additionally, the text information is acquired in a format compatible with the visualization software 7. Therefore, the processor 2 can supply this text information to the visualization software 7 and the processor 2 can operate the visualization software 7. As a result, visual information is generated by the visualization software 7. In this embodiment, the generated visual information includes simulation results and graphs that provide specific examples of technical matter X. The generated visual information is supplied from the visualization software 7 to the content generation system 1 (Step S79). Thus, the processor 2 acquires visual information from the visualization software 7 for inclusion in the content (Step S20).

### Process (E)

After Processes (B) to (D), the processor 2 generates content that includes at least a part of the communicative human language information acquired in Process (B) and at least a part of the visual information acquired in Process (D) (Process (E)).

### Process (F)

The processor 2 outputs the content generated in Process (E) from the communication module 4 via network 12 to the user terminal device 11 (Process (F)). The user terminal device 11 receives the content (Step S121) and outputs the content (Step S122). The manner of outputting the content is not particularly limited. The outputted content could be displayed on a display equipped on the user terminal device 11 or could be provided as a data file.

The present invention is not limited to the above embodiments. The invention can be implemented in other embodiments, and various modifications can be added. To facilitate understanding, an example is added below regarding the flowchart shown in FIG. 1(b). The technical matter X is considered to be “heat generation due to electric current flowing through a metal material.” At Step S111, the input is, for example, “Please generate technical documentation on ‘heat generation due to electric current flowing through a metal material.’”

Regarding Process (B), at Step S12, the inputted request could be sent to LLM 6. The “communicative human language information for content” at Step S62, and the “communicative human language information to be included in the content” at Step S13, could be, for instance, detailed explanations about “heat generation due to electric current flowing through a metal material.” Specifically, this might include descriptions of the principles of heat generation, factors affecting the amount of heat generated, and applications of heat generation in metal materials due to electric current. Additionally, regarding “a general formula for explaining technical matter X, as well as variables contained in this general formula,” a “general formula” could be the heat conduction equation, for example. “Variables” might include the geometry and material properties of the metal (thermal conductivity, specific heat capacity), current path, initial temperature conditions, boundary conditions, and heat sources (Joule heating due to the electric current), among others.

For Process (C), the “communicative human language information” supplied to LLM6 at Step S14 could include enquiries about visualization software 7 that is capable of conducting simulations using the aforementioned general formulas and variables. The “communicative human language information for selecting visualization software 7” at Step S64 might include the names of specific simulation tools and information related to the features of said tools. If the “communicative human language information for selecting visualization software 7” includes only the name of one simulation tool (e.g., ANSYS®), that tool would be selected as the visualization software 7 to be used. If multiple simulation tool names are included, processor 2 may make a selection of one of the simulation tools to be used as visualization software 7, or further communication with LLM6 may occur, resulting in the selection of a simulation tool.

In Process (D), “the enquiry about the type and value of data to be entered into visualization software 7 to obtain visual information representing technical matter X” at Step S17 could be, for example, enquiries about the type and value of data required by the simulation tool to obtain simulation results illustrating “heat generation due to electric current flowing through a metal material.” The “text information” at Steps S67 and S18 might include the data to be entered into the simulation tool, encompassing values for each type of data (i.e., parameters). Processor 2, at Step S19, supplies this data to the simulation tool, thereby obtaining simulation results that illustrate “heat generation due to electric current flowing through a metal material.”

In Process (E), the communicative human language information obtained in Process (B) consists of detailed explanations about “heat generation due to electric current flowing through a metal material,” and any visual information obtained in Process (D) comprises the simulation results illustrating “heat generation due to electric current flowing through a metal material.” Based on these, the content, namely the technical documentation on “heat generation due to electric current flowing through a metal material,” is generated. It should be noted that this invention is not limited to the above example.

### EXPLANATION OF SYMBOLS

1: Content generation system
2: Processor
3: Memory
4: Communication module
6: LLM
7: Visualization software
11: User terminal device
12: Network

What is claimed is:

1. A content generation system for generating a content, comprising:
at least one user interface,
at least one memory,
at least one processor configured to execute at least one program stored in said at least one memory and connected to said at least one memory, wherein said at least one program is programmed to be executed by said at least one processor to:
(A) utilize both
a Large Language Model (LLM) that operates using communicative human language information entered through said at least one user interface, and
a visualization software programmed to output visual information using text information,
(B) acquire first communicative human language information to be included in the content by the LLM using at least a part of the communicative human language information entered through said at least one user interface,
(C) acquire second communicative human language information by the LLM for selecting the visualization software that is configured to generate the visual information to be included in the content, based on at least a part of the communicative human language information entered through said at least one user interface, and select the visualization software based on the acquired second communicative human language information,
(D) acquire the visual information to be included in the content by operating the selected visualization software using the text information, which is based on an output of the LLM in correspondence to the communicative human language information entered through said at least one user interface,
(E) generate the content including at least a part of the first communicative human language information, or a modification thereof, acquired from (B), and at least a part of the visual information, or a modification thereof, acquired from (D), and
(F) output the generated content through said at least one user interface.

2. The content generation system of claim 1, wherein the visualization software is selected by the content generation system, not by a user.

3. The content generation system of claim 1, wherein the content generation system is configured so as not to be embedded in any specific visualization software and not to be associated only with any specific visualization software.

4. The content generation system of claim 1, wherein the visualization software is data visualization software or includes a visual-based model.

5. The content generation system of claim 1, wherein the at least one program is programmed to be executed by the at least one processor such that:
in the step (C),
if the second communicative human language information acquired by the LLM includes information indicating a name of the visualization software, then the visualization software is selected based on that name, or
a web search is performed using the second communicative human language information acquired by the LLM, and then the visualization software is selected based on information acquired from the web search.

6. The content generation system of claim 1, wherein
the communicative human language information entered through said at least one user interface includes subject matter of the content, and
the content is generated to promote a user's understanding or provide detailed explanations or descriptions about the subject matter included in the communicative human language information entered through said at least one user interface.

7. The content generation system of claim 1, wherein
the communicative human language information entered through said at least one user interface includes subject matter of the content and is a query that consists of a command, a request, or a question, or a combination thereof, and
the content is generated to explain or describe the subject matter in accordance with the query.

8. The content generation system of claim 1, wherein the first communicative human language information in the content has a larger text count than the communicative human language information entered through said at least one user interface.

9. The content generation system of claim 1, wherein the first communicative human language information and the visual information included in the content are mutually related and are also related to subject matter of the content.

10. The content generation system of claim 1, wherein the visual information is added to supplement explanations or descriptions made by the communicative human language information in the content.

11. The content generation system of claim 1, wherein
the visual information is either an image which is static visual information, or a video which is dynamic visual information, and
the image encompasses visualizations, and
the video encompasses animations or simulations.

12. The content generation system of claim 1, wherein
said at least one program is further programmed to be executed by said at least one processor to utilize the visualization software after the visualization software is selected, as the visualization software to be selected is not determined before the start of use of the content generation system.

13. A system for generating a content in response to an input in communicative human language, the system being configured to communicate with:
a user terminal device configured to
receive the input in the communicative human language, to thereby generate communicative human language (CHL) information, and
output the generated content,
a first server configured to provide a Large Language Model (LLM), and
a second server configured to provide a plurality of pieces of visualization software,
the system comprising:
a processor; and
a non-transitory storage medium containing program instructions, execution of which by the processor causes the system to:
receive the CHL information from the user terminal device;
send the CHL information to the first server, to thereby obtain a first output of the LLM, the first output including output content in the communicative human language;
resend the CHL information to the first server, to thereby obtain a second output of the LLM, the second output including information designating one of the plurality of pieces of visualization software;
further resend the CHL information to the first server, to thereby obtain a third output of the LLM, the third output including text information for the designated one of the plurality of pieces of visualization software;
send the text information to the second server, to thereby obtain output content including visual information from the designated one of the plurality of pieces of visualization software;
generate the content based on both the output content in the communicative human language, and the output content including the visual information; and
send the generated content to the user terminal device to be outputted thereby.

14. The system of claim 12, wherein at least one of the first and second servers include a plurality of server devices that communicate with one another.

15. The system of claim 12, wherein the content generated by the system further includes at least one of a modification of the output content in the communicative human language, and a modification of the output content including the visual information.

16. A method for a content generation system that generates a content in response to an input in communicative human language, the content generation system being configured to communicate with:
a user terminal device configured to
receive the input in the communicative human language, to thereby generate communicative human language (CHL) information, and
output the generated content,
a first server configured to provide a Large Language Model (LLM), and
a second server configured to provide a plurality of pieces of visualization software,
the method comprising:
receiving the CHL information from the user terminal device;
sending the CHL information to the first server, to thereby obtain a first output of the LLM, the first output including output content in the communicative human language;
resending the CHL information to the first server, to thereby obtain a second output of the LLM, the second output including information designating one of the plurality of pieces of visualization software;
further resending the CHL information to the first server, to thereby obtain a third output of the LLM, the third output including text information for the designated one of the plurality of pieces of visualization software;
sending the text information to the second server, to thereby obtain output content including visual information from the designated one of the plurality of pieces of visualization software;
generating the content based on both the output content in the communicative human language, and the output content including the visual information; and
sending the generated content to the user terminal device to be outputted thereby.

17. The method of claim 15, wherein at least one of the first and second servers include a plurality of server devices that communicate with one another.

18. The method of claim 15, wherein the generating the content further includes:
modifying at least one of the output content in the communicative human language and the output content including the visual information; and
generating the content that includes a result of the modification.
